(19) United States
(12) Patent Application Publication
(10) Pub. No.: US 2025/0279085 A1
(43) Pub. Date: Sep. 4, 2025

(54) MULTI-MODAL ADVERSARIAL TRAINING FOR ZERO-SHOT VOICE CLONING

(71) Applicant: Zoom Video Communications, Inc., San Jose, CA (US)

(72) Inventors: Dading Chong, Hangzhou (CN); Dongyang Dai, Shanghai (CN); John Janiczek, Westminster, CO (US); Yuzong Liu, Bothell, WA (US); Chao Wang, Yancheng (CN); Tao Wang, Hangzhou (CN)

(73) Assignee: Zoom Video Communications, Inc., San Jose, CA (US)

(21) Appl. No.: 18/824,379

(22) Filed: Sep. 4, 2024

Related U.S. Application Data
(63) Continuation-in-part of application No. PCT/CN2024/079658, filed on Mar. 1, 2024.

(51) Int. Cl. G10L 13/047; G10L 13/10

(52) U.S. Cl. CPC G10L 13/047; G10L 13/10

(57) ABSTRACT

Systems and methods of multi-modal adversarial training for zero-shot voice cloning are provided. A communication platform provides training transcript data and training speaker data to a text-to-speech (TTS) model to obtains synthesized audio data comprising synthesized acoustic features and synthesized prosodic features. The communication platform determines determine a first classification prediction using a first discriminator model and a second classification prediction using a second discriminator model. The communication platform trains the first discriminator model and the second discriminator model based on the first classification prediction and the second classification prediction. The communication platform trains the TTS model to obtain a trained TTS model based on ground truth acoustic features, ground truth prosodic features, the synthesized acoustic features, the synthesized prosodic features, the first classification prediction, and the second classification prediction.

### CROSS-REFERENCE TO RELATED APPLICATIONS

This application is a continuation-in-part of PCT Patent Application No. PCT/CN2024/079658, filed Mar. 1, 2024, titled “MULTI-MODAL ADVERSARIAL TRAINING FOR ZERO-SHOT VOICE CLONING,” the entirety of which is hereby incorporated by reference.

### FIELD

The present application generally relates to text-to-speech synthesis and more specifically relates to multi-modal adversarial training for zero-shot voice cloning.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionality to various client devices;

FIG. 2 shows an example system in which a chat and video conference provider provides chat and videoconferencing functionality to various client devices;

FIG. 3 shows an example system that can establish a virtual communication session;

FIG. 4 shows an example system that is configured for multi-modal adversarial training for zero-shot voice cloning;

FIG. 5 shows an example diagram of a multi-modal generative adversarial network (GAN) training framework;

FIG. 6 shows an example GUI displaying a consent authorization request for accessing personal data;

FIG. 7 shows an example process for multi-modal adversarial training for zero-shot voice cloning;

FIG. 8 shows an example process for speech synthesis using the TTS model trained in FIG. 7;

FIG. 9 shows an example computing device suitable for use in example systems or methods for multi-modal adversarial training for zero-shot voice cloning.

### DETAILED DESCRIPTION

Examples are described herein in the context of multi-modal adversarial training for zero-shot voice cloning. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Text-to-speech (TTS) models are used to generate human-like speech from a given text input. Neural networks have been used to synthesize speech that nearly matches the naturalness of human speech. Recently, there has been an interest in extending neural TTS with advanced features such as zero-shot voice cloning. A zero-shot system implements voice cloning by encoding speech from a short reference audio without requiring any additional training or fine-tuning, unlike few-shot systems. It is a challenging to achieve natural and expressive speech using TTS models because the neural network must extrapolate to unseen speakers and there is still a quality gap between zero-shot and few-shot systems. TTS models trained with a reconstruction loss tend to make over-smooth predictions that are close to the average behavior of the dataset rather than capturing the diversity of human speech.

To improve the TTS quality in zero-shot voice cloning, an example multi-modal adversarial training framework may be used to train a TTS generator. The example multi-modal adversarial training framework includes two discriminators, an acoustic discriminator for distinguishing between synthesized acoustic features and the ground truth acoustic features, and a prosodic discriminator for distinguishing between synthesized prosodic features and the ground truth prosodic features. The acoustic discriminator and the prosodic discriminator have similar structures, each including a transformer-based encoder and a transformer-based decoder.

During training, the TTS generator generates a synthesized audio clip based on a transcript corresponding to a training audio clip along with corresponding speaker information. The speaker information includes an audio sample extracted from the training audio clip, which represents certain voice features. The TTS generator extracts acoustic features and prosodic features from the synthesized audio clip, which can be called synthesized acoustic features and synthesized prosodic features. Meanwhile, ground truth acoustic features and ground truth prosodic features are extracted from the training audio clip.

The acoustic discriminator is trained to differentiate between the synthesized acoustic features and the ground truth acoustic features. During training, the synthesized acoustic features or the ground truth acoustic features are randomly provided to the acoustic discriminator, along with the speaker information and the text associated with the training audio clip. The acoustic discriminator generates a prediction indicating whether the received acoustic features are from the synthesized audio or the training audio. In other words, the acoustic discriminator predicts if the received acoustic features are from a real (ground truth training) audio or a fake (synthesized) audio.

Similarly, the prosodic discriminator is trained to differentiate between the synthesized prosodic features and the ground truth prosodic features. During training, the synthesized prosodic features or the ground truth prosodic features are randomly provided to the prosodic discriminator, along with the speaker information associated with the training audio. The prosodic discriminator generates a prediction indicating the received prosodic features are from the synthesized audio or the training audio. In other words, the prosodic discriminator predicts if the received prosodic features are from a real (ground truth training) audio or a fake (synthesized) audio.

The predictions from the acoustic discriminator and the prosodic discriminator are then used to guide the training of the TTS generator with an adversarial loss. During training, the TTS generator tries to generate audio data that the acoustic discriminator or the prosodic discriminator cannot distinguish from ground truth audio data, while the acoustic discriminator and the prosodic discriminator try to get better at differentiating ground truth training audio from the synthesized audio. This adversarial process leads to the TTS generator creating increasingly better audio over time.

Thus, a TTS generator is trained by a multi-feature generative adversarial training framework. The trained TTS generator improves the quality of both acoustic features and prosodic features of the synthesized speech. In other words, the synthesized speech is more natural and expressive.

This illustrative example is given to introduce the reader to the general subject matter discussed herein and the disclosure is not limited to this example. The following sections describe various additional non-limiting examples and examples of multi-modal adversarial training for zero-shot voice cloning.

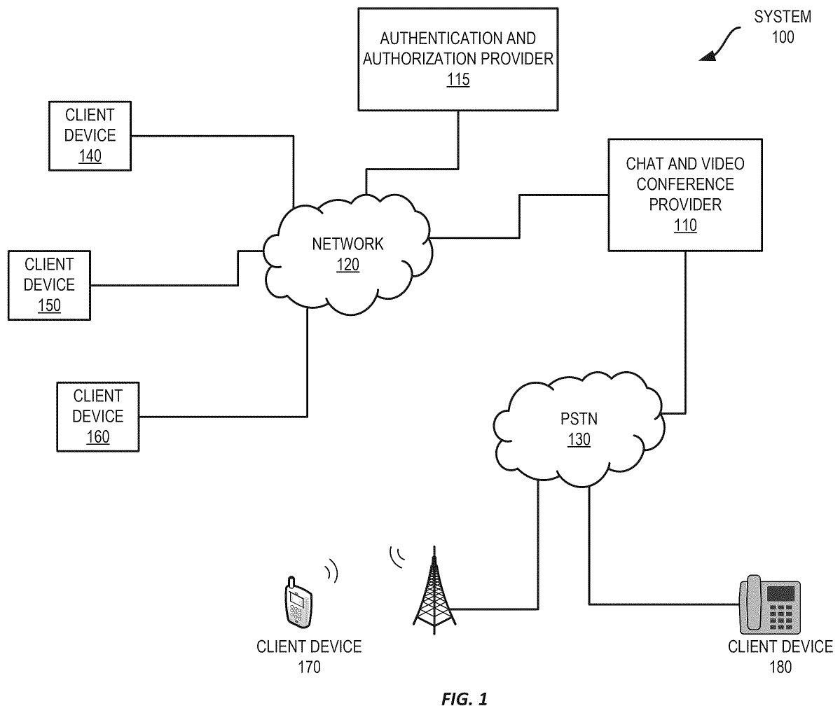

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

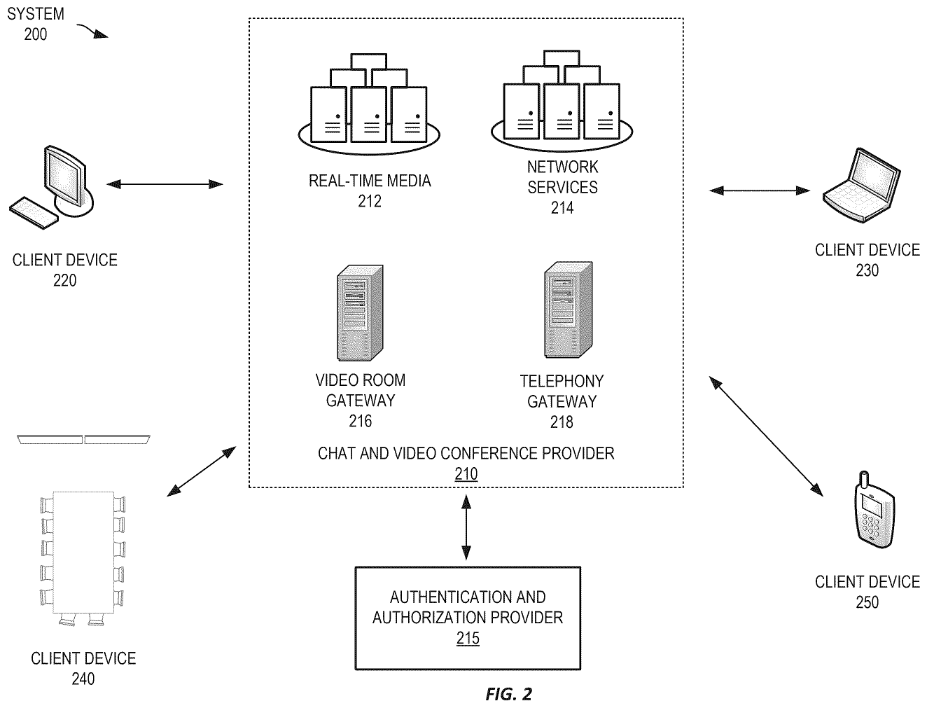

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

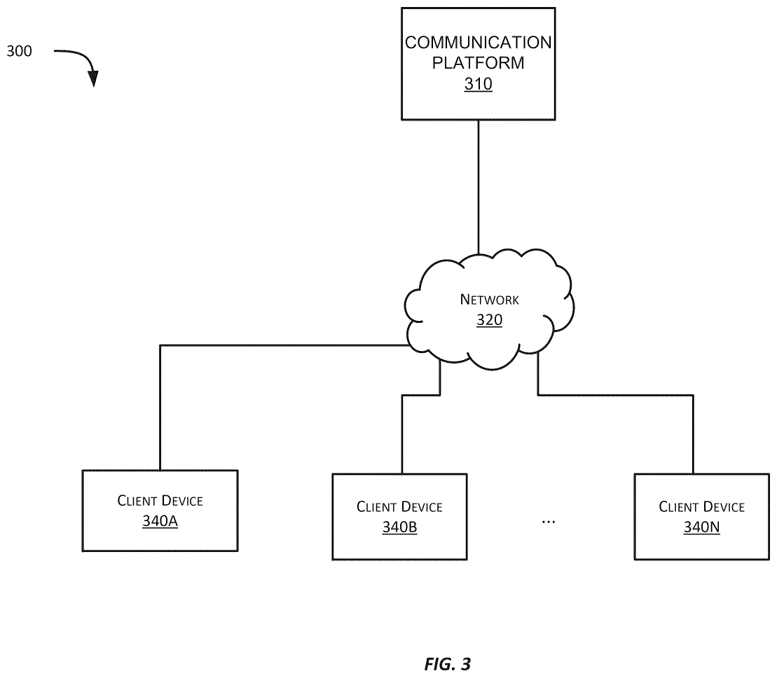

Referring now to FIG. 3, FIG. 3 shows an example system 300 that can establish a virtual communication session. In this example system 300, a communication platform 310 and a number of client devices 340A-340N (which may be referred to herein individually as a client device 340 or collectively as the client devices 340) are connected via a network 320. The communication platform 310 can be the chat and video conference provider 110 in FIG. 1 or the chat and video conference provider 210 in FIG. 2. The network 320 can be the internet or any suitable communications network or combination of communications network may be employed, including LANs (e.g., within a corporate private LAN), WANs, MANS, cellular network (e.g., 3G, 4G, 4G LTE, 5G, etc.), or any combination of these.

The client devices 340 can be any suitable computing or communications device. The client device 340 can be a client device (e.g., 140, 150, 160, or 170) in FIG. 1 or a client device (e.g., 220, 230, or 250) in FIG. 2. For example, client devices 340 may be desktop computers, laptop computers, tablets, smart phones having processors and computer-readable media, connected to the communication platform 310 using the internet or other suitable computer network. The client devices 340 have communication software installed to enable them to connect to the communication platform 310 for chats, video conferences, emails, and any other suitable communications. For example, during a video conference session, a user associated a client device (e.g., client device 340A) can interact with other users associated with other client devices (e.g., client device 340B-340N) via the communication platform 310 via audio and video.

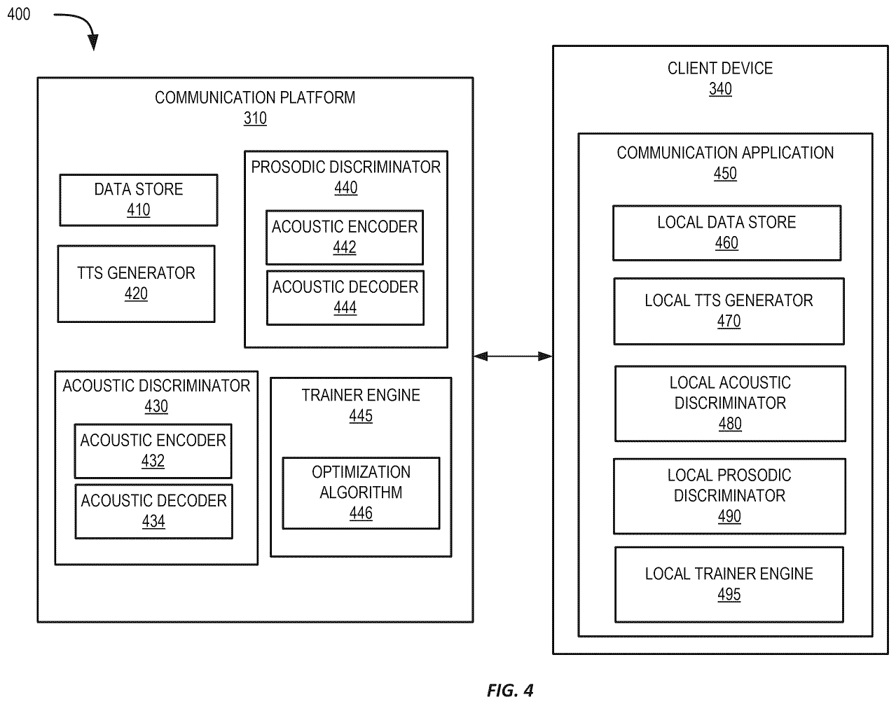

Referring now to FIG. 4, FIG. 4 shows an example system that is configured for multi-modal adversarial training for zero-shot voice cloning. The communication platform 310 is in network communication with a client device 340. The communication platform 310 includes a data store 410, a TTS generator 420, an acoustic discriminator 430, a prosodic discriminator 440, and a trainer engine 445.

The data store 410 stores historical input data to the TTS generator 420, including transcript text and speaker information, and corresponding output data, such as synthesized audios. In some examples, the data store 410 also stores training data used for training the TTS generator 420, the acoustic discriminator 430, and the prosodic discriminator 440. Example training data includes training audios, corresponding training transcripts, training speaker information, ground truth acoustic features, and ground truth prosodic features. The data store 410 also stores intermediate data generated during a process of training the TTS generator 420, the acoustic discriminator 430, and the prosodic discriminator 440. Example intermediate data includes synthesized audio by the TTS generator 420 during training, synthesized acoustic features, synthesized prosodic features, real/fake predictions by the acoustic discriminator 430, real/fake predictions by the prosodic discriminator 440, calculated losses, and weight parameters determined during the training process, as will be described below.

The TTS generator 420 is configured to generate synthesized audio based on text input and speaker information. The TTS generator 420 includes an acoustic model and a vocoder. The acoustic model converts input text conditioned on speaker information into spectrograms. The acoustic model includes a speaker encoder, a synthesizer encoder, a variant adaptor, and a synthesizer decoder. The speaker encoder is pre-trained using one or more independent datasets to generate speaker embeddings. In this example, the synthesizer encoder and synthesizer decoder in the TTS generator 420 are feed-forward transformer blocks including a stack of self-attention layers and 1D-convolution layers. The synthesizer encoder converts phoneme embedding sequence into phoneme hidden sequence. The variance adaptor adds different variance information into the hidden sequence. The variant adaptor includes acoustic feature predictors and prosodic feature predictors to predict acoustic features and prosodic features based on the phoneme embeddings and speaker embeddings. Example acoustic features include pitch, energy, and duration. Example prosodic features include rhythm, stress, and intonation. The synthesizer decoder converts the adapted hidden sequence into spectrogram sequences (e.g., Mel-spectrogram sequence). The vocoder generates audio waveforms based on the spectrogram to provide synthesized audios.

The acoustic discriminator 430 is configured to predict whether an acoustic feature input is from a synthesized audio or an audio recorded from a real person. The acoustic discriminator 430 includes an acoustic encoder 432, an acoustic decoder 434, and additional convolutional layers (not shown) at the input. The acoustic encoder 432 and the acoustic decoder 434 includes a transformer model each. The convolution layers extract embeddings from input data, including text input and speaker information, and received acoustic features. The acoustic encoder 432 and the acoustic decoder 434 may have the same number of transformer layers or different number of transformer layers. The acoustic encoder 432 encodes the text input and speaker information, and the acoustic decoder decodes the received acoustic features and the encoded text input and speaker information to provide a prediction whether the received acoustic features are from a real audio or a synthesized audio.

The acoustic discriminator 430 is used for training the TTS generator 420. During training, the acoustic discriminator 430 takes the text input and speaker information as context input, and a set of acoustic features as feature input, and generates a real or fake prediction indicating if the set of acoustic features is from a real audio or a fake audio.

Similarly, the prosodic discriminator 440 is configured to predict if a prosodic feature input is from a synthesized audio or an audio recorded from a real person. In this example, the prosodic discriminator 440 includes a prosodic encoder 442, a prosodic decoder 444, and additional convolutional layers (not shown) at the input. The prosodic encoder 442 and the prosodic decoder 444 each include a transformer model. The prosodic encoder 442 and the prosodic decoder 444 may have the same number of transformer layers or different number of transformer layers. In some examples, the prosodic discriminator 440 has the same size as that of the acoustic discriminator 430. In some examples, the prosodic discriminator 440 is smaller than acoustic discriminator 430, for example half the size of the acoustic discriminator 430.

The prosodic discriminator 440 is used for training the TTS generator 420. During training, the acoustic discriminator 430 takes the text input and speaker information as context input, and a set of prosodic features as feature input, and generates a real or fake prediction indicating if the set of prosodic features is from a real audio or a fake audio.

The trainer engine 445 is configured to train the TTS generator 420 using a generative adversarial network (GAN) training framework. In some examples, the trainer engine 445 trains the acoustic discriminator 430 and the prosodic discriminator 440 first, and then trains the TTS generator 420. During training, a training text input and training speaker information corresponding to a training audio are provided to the TTS generator 420 to be trained. The TTS generator 420 generates a synthesized audio with synthesized acoustic features and synthesized prosodic features. The synthesized acoustic features and ground-truth acoustic features extracted from the training data sample can be randomly provided to the acoustic discriminator 430. The acoustic discriminator 430 generates a prediction whether the acoustic features are from a real audio (e.g., training audio) or a fake audio (e.g., the synthesized audio). Subsequently or in parallel, the synthesized prosodic features and ground-truth prosodic features extracted from the training data sample are randomly provided to the prosodic discriminator 440. The prosodic discriminator 440 generates a prediction whether the prosodic features are from a real audio (e.g., training audio) or a fake audio (e.g., synthesized audio). The trainer engine 445 uses or implements an optimization algorithm 446, for example Adam optimization algorithm, to minimize a discriminator loss based on the predictions from the acoustic discriminator 430 and the prosodic discriminator 440, thereby obtaining optimized parameters for the acoustic discriminator 430 and the prosodic discriminator 440.

Then the trainer engine 445 freezes the acoustic discriminator 430 and the prosodic discriminator 440. In other words, the parameters for the acoustic discriminator 430 and the prosodic discriminator 440 are unchanged when training the TTS generator 420. The trainer engine 445 uses or implements the optimization algorithm 446 to minimize an optimization loss including a generator loss with an adversarial loss to obtain optimized parameters for the TTS generator 420. When the TTS generator 420 is trained, it can be deployed to convert text input conditioned on speaker information to more natural and expressive speech.

The client device 340 is installed with a communication application 450 provided by the communication platform 310. In some examples, the communication application 450 installed on the client device 340 includes a local data store 460, a local TTS generator 470, a local acoustic discriminator 480, a local prosodic discriminator 490, and a local trainer engine 495. The local data store 460 stores local input data to the local TTS generator 470, including transcript text and speaker information, and corresponding output data, such as locally synthesized audios. In some examples, the data store 410 also stores training data used for training the TTS generator 420 and intermediate data generated during the training. The local TTS generator 470 is configured to generate synthesized audio based on text input and speaker information, similar to the TTS generator 420 on the communication platform 310. The local acoustic discriminator 480 is configured to predict whether an acoustic feature input is from a synthesized audio or an audio recorded from a real person, similar to the acoustic discriminator 430 on the communication platform 310. The local prosodic discriminator 490 is configured to predict whether a prosodic feature input is from a synthesized audio or an audio recorded from a real person, similar to the prosodic discriminator 440 on the communication platform 310. The local trainer engine 495 is configured to train the local TTS generator 470 using a generative adversarial network (GAN) training framework, similar to the trainer engine 445 on the communication platform 310.

The communication application 450 also includes a graphical user interface (GUI) for receiving user inputs and displaying synthesized audios. In some examples, the GUI includes an embedded audio player for the user to play the synthesized audios. In some examples, the synthesized audios are provided to another module in the communication application 450 or on the communication platform 310. For example, a user cannot speak or chooses not to speak his own voice in a video conference, but elects to use synthesized voice. The user enters the text of what he wants to say and selects a speaker style (e.g., a voice sample), and the local TTS generator 470 on the communication application 450 generates synthesized audio based on the text and the selected speaker style and provides to the video conferencing model for streaming during the video conference.

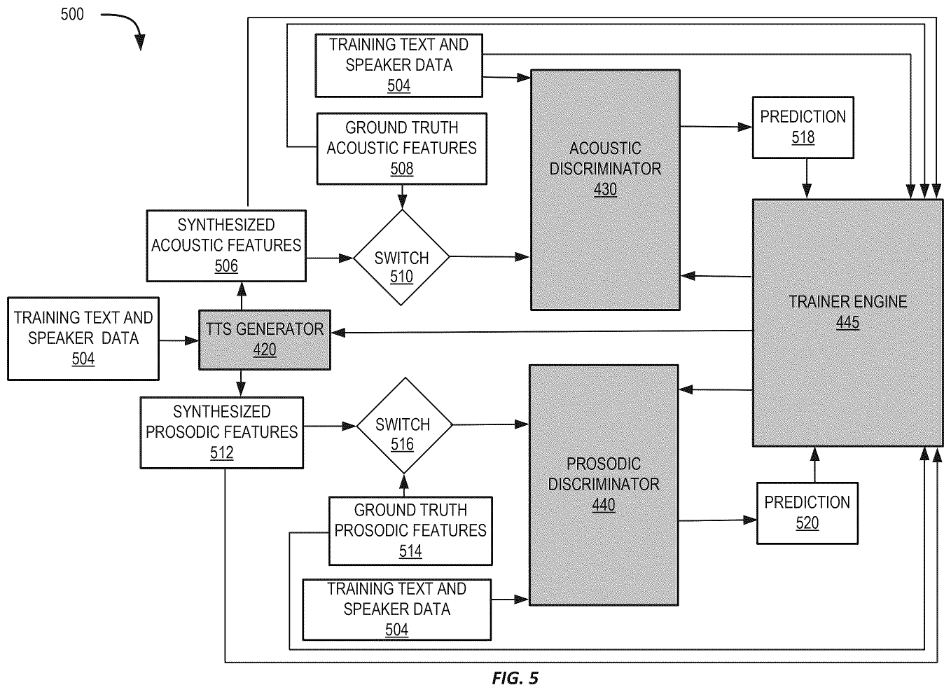

Referring now to FIG. 5, FIG. 5 shows an example diagram 500 of a multi-modal generative adversarial network (GAN) training framework. During training, the trainer engine 445 provides a set of training text and speaker data 504 to the TTS generator 420. The set of training text and speaker data 504 includes a training transcript corresponding to a training audio and related speaker information. The related speaker information is an audio sample from the training audio. The TTS generator 420 generates a synthesized audio, which includes synthesized acoustic features 506 and synthesized prosodic features 512. Meanwhile, ground truth acoustic features 508 and ground truth prosodic features 514 are extracted from the training audio.

The synthesized acoustic features 506 and the ground truth acoustic features 508 are provided to the acoustic discriminator 430 randomly via a switch 510. The acoustic discriminator 430 generates a prediction 518 indicating whether the received acoustic features are from a real audio (e.g., training audio) or a fake audio (e.g., the synthesized audio).

Meanwhile, the synthesized prosodic features 512 and the ground truth prosodic features 514 are provided to the prosodic discriminator 440 randomly via a switch 516. The prosodic discriminator 440 generates a prediction 520 indicating whether the received prosodic features are from a real audio (e.g., training audio) or a fake audio (e.g., the synthesized audio).

The trainer engine 445 determines an acoustic discriminator loss based on the set of training text and speaker data 502, the synthesized acoustic feature 506, and the ground truth acoustic features 508, as shown in Equation (1).

$$( 1 )$$

$${ℒ}_{D 1} = - min ( 0 , {D}_{1} ( {g t}_{} \vert text , spk ) - 1 ) - min ( 0 , - {D}_{1} ( {p r e}_{} \vert text , spk ) - 1 )$$

Equation (1) is a conditional hinge loss function, where D₁ is the prediction by the acoustic discriminator 430, [symbol] _{gt} represents the ground truth acoustic features, and [symbol] ₚᵣₑ represents the synthesized acoustic features, text represents the training text, and spk represents the speaker data associated with the training text.

Similarly, the trainer engine 445 determines a prosodic discriminator loss based on the set of training text and speaker data 502, the synthesized prosodic feature 512, and the ground truth prosodic features 514, as shown in Equation (2).

$${ℒ}_{D 2} = - min ( 0 , {D}_{2} ( {P}_{g t} \vert text , spk ) - 1 ) - min ( 0 , {D}_{2} ( {P}_{p r e} \vert text , spk ) ) - 1 ) \qquad ( 2 )$$

Equation (2) is a conditional hinge loss, where D₂ is the prediction by the prosodic discriminator 440, P_{gt} represents the ground truth prosodic features, Pₚᵣₑ represents the synthesized prosodic features, text represents the training text, and spk represents the speaker data associated with the training text.

The trainer engine 445 then minimizes the total discriminator loss as shown in Equation (3) to obtain optimized parameters for the acoustic discriminator 430 and the prosodic discriminator 440. In other examples, the parameters for the acoustic discriminator 430 and the parameters for the prosodic discriminator 440 are optimized separately by minimizing the acoustic discriminator loss [symbol] _{D}_{₁} as shown in Equation (1) and minimizing prosodic discriminator loss [symbol] _{D}_{₂} as shown in Equation (2) respectively.

$${ℒ}_{d i s} = {ℒ}_{{D}_{1}} + {ℒ}_{{D}_{2}} \qquad ( 3 )$$

The trainer engine 445 implements the multi-modal GAN training framework for training the TTS generator 420. The trainer engine 445 determines an acoustic generation loss [symbol] _{gen1} as shown in Equation (4). In Equation (4), MAE represents the mean absolute error, [symbol] _{gt} represents the ground truth acoustic features, and [symbol] ₚᵣₑ represents the synthesized acoustic features.

$${ℒ}_{gen 1} = MAE ( {pre}_{} , {g t}_{} ) \qquad ( 4 )$$

Meanwhile, the trainer engine 445 determines a first adversarial loss associated with the acoustic discriminator 430, as shown in Equation (5), to guide the optimization of the acoustic features. In the multi-modal GAN training network, the TTS generator 420 tries to deceive the acoustic discriminator 430 and the prosodic discriminator 440, and the goal of the acoustic discriminator 430 and the prosodic discriminator 440 is to correctly identify if the input features are from a real or fake audio. In other words, the generator and the discriminators are in an adversarial relationship. Thus, the first adversarial loss associated with the acoustic features is the opposite of the acoustic discriminator loss.

$${ℒ}_{adv 1} = - {D}_{1} ( {pre}_{} \vert text , spk ) \qquad ( 5 )$$

Similarly, the trainer engine 445 determines a prosodic generation loss [symbol] _{gen2} as shown in Equation (6), where MAE represents the mean absolute error, P_{gt} represents the ground truth prosodic features, and Pₚᵣₑ represents the synthesized prosodic features. The trainer engine 445 also determines a second adversarial loss associated with the prosodic features as shown in Equation (7).

$${ℒ}_{gen 2} = M S E ( {P}_{p r e} , {P}_{g t} ) \qquad ( 6 )$$

$${ℒ}_{adv 2} = - {D}_{2} ( {P}_{p r e} \vert text , spk ) ) \qquad ( 7 )$$

The total optimization loss associated with the TTS generator 420 is shown in Equation (8). It is notes that when training the TTS generator 420, only the parameters for the TTS generator 420 are updated, while the acoustic discriminator 430 and the prosodic discriminator 440 are frozen. That is, the parameters for the acoustic discriminator 430 and the parameters for the prosodic discriminator 440 are unchanged.

$${ℒ}_{g e n} = {ℒ}_{gen 1} + {ℒ}_{gen 2} + {ℒ}_{adv 1} + {ℒ}_{adv 2} \qquad ( 8 )$$

It is noted that the speaker encoder in the TTS generator 420 is pre-trained and is frozen during the training of the TTS generator 420 as described in FIG. 5 herein. In some examples, the prosodic discriminator 440 has a smaller size than that of the acoustic discriminator 430, for example half the size of the acoustic discriminator.

The TTS generator 420 trained by the multi-modal GAN training framework as described in FIG. 5 can be evaluated using a set of evaluation datasets different from the training datasets. Evaluation metrics include Non-Intrusive Objective Speech Quality Assessment Mean Opinion Score (NISQA MOS), speaker similarity, and pitch standard deviation. The NISQA MOS metric uses a pre-trained model to predict human preference and has been shown to correlate with quality of speech when averaged over a sufficient number of samples. The speaker similarity metric takes the cosine similarity between speaker embeddings from the synthesized speech and the reference training audio. A different speaker encoder can be used for evaluation of the TTS generator 420, because speaker encoders tend to give higher scores when the TTS generator 420 is trained with the same speaker encoder. This bias can be removed with a different speaker encoder. Pitch standard deviation represents how the variation in pitch compares between ground truth and synthesized examples as a proxy for how expressive the speech is. The pitch standard deviation is calculated for each utterance and then averaged across the test set so that the variation is dominated by differences in pitch within the utterance rather than differences in pitch between different speakers.

The performance of the TTS generator 420 trained using the multi-modal GAN training framework in the present disclosure is compared with a baseline TTS generator trained without discriminators. Table 2 shows comparison of evaluation metrics for the performance on a task of synthesizing unseen speakers.

TABLE 1
Comparison of Evaluation Metrics
for Audio Synthesis Performance

| Metric | Reference | Baseline | Present |
|---|---|---|---|
| NISQA MOS ↑ | 4.24 | 3.30 | 4.18 |
| Speaker Similarity ↑ | 1.00 | 0.54 | 0.62 |
| Pitch Std. | 35.14 | 26.37 | 34.59 |

It can be seen in Table 1 that the TTS generator trained with the present training framework shows significant performance improvements over the baseline TTS generator with higher NISQA-MOS and speaker similarity scores. The pitch standard deviation is also closer to ground truth reference indicating that the prosody of present TTS generator is more expressive.

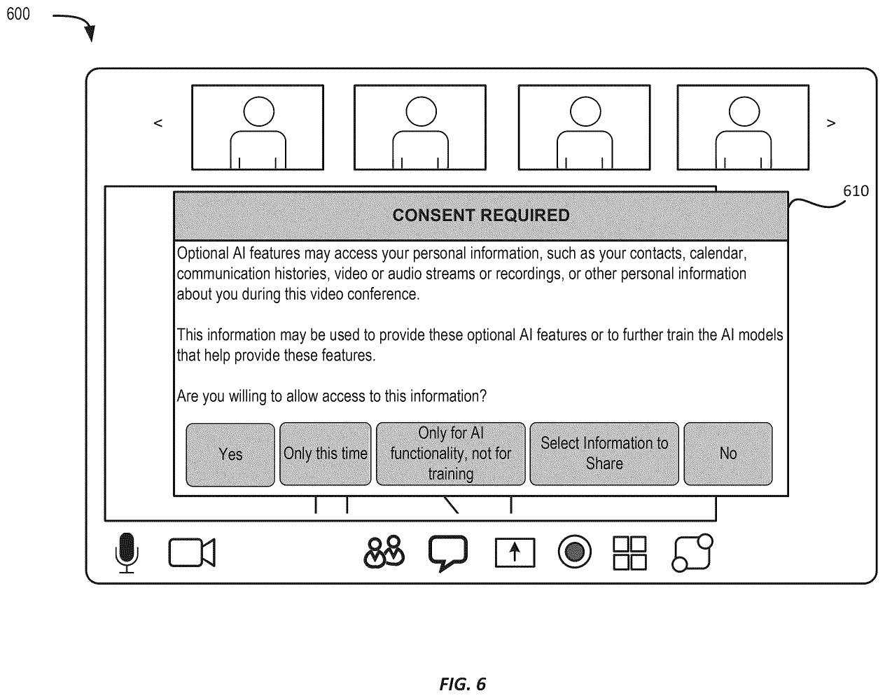

Referring now to FIG. 6, FIG. 6 shows an example GUI 600 displaying a consent authorization request for accessing personal data. In some examples according to the present disclosure, a user may select an option to use one or more optional AI features available from a communication platform, such as the chat and video conference provider 110 or the chat and video conference provider 210. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to provide training data for the underlying AI models, the user may be provided with an option to consent, or deny consent, to access and use some or all of the user's personal information. In general, Applicant's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default—account owners and administrators control whether to enable these AI features for their accounts, and if enabled, individual users may determine whether to provide consent to use their personal information.

As can be seen in FIG. 6, a user has engaged in a video conference and has selected an option to use an available optional AI feature. In response, the GUI has displayed a consent authorization window 610 for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

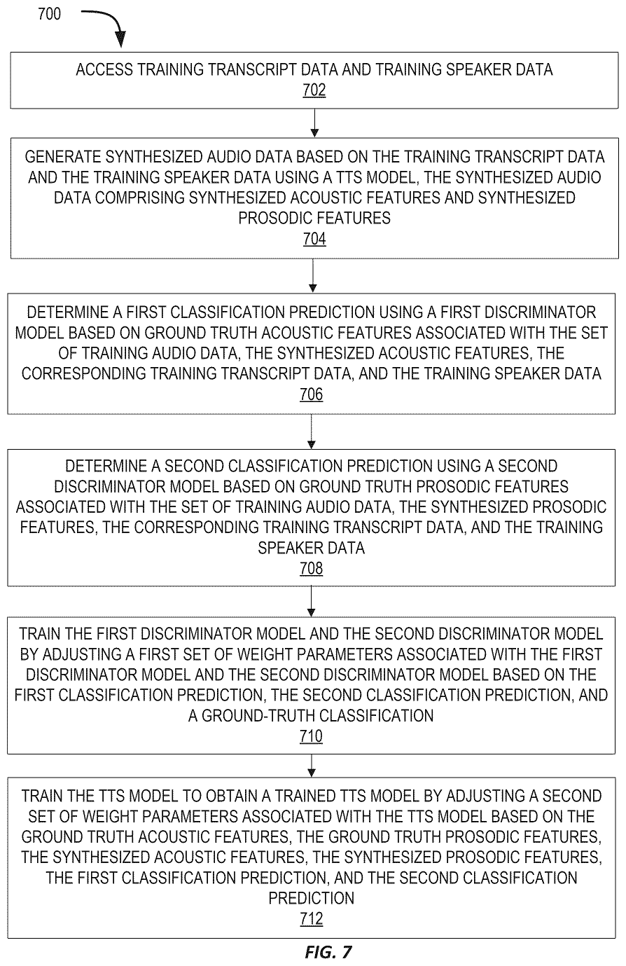

Referring now to FIG. 7, FIG. 7 shows an example process 700 for multi-modal adversarial training for zero-shot voice cloning. The example process 700 will be discussed with respect to the system 400 shown in FIG. 4; however, any suitable system for multi-modal adversarial training for zero-shot voice cloning may be used. Further, while the system 400 is described with respect to a communications platform 310, any suitable service provider or other computing device may be used in place of the communication platform to perform methods according to this disclosure.

At block 702, a communication platform 310 accesses training transcript data and training speaker data. The trainer engine 445 on the communication platform 310 accesses the data store 410 to retrieve training audio data and corresponding training transcript data. Alternatively, the set of training audio data and corresponding training transcript data are retrieved from a third-party database. In some examples, the training speaker data includes a training audio sample from the training audio data representing a training speaker voice.

At block 704, the communication platform 310 generates synthesized audio data based on the training transcript data and the training speaker data using a TTS model to obtain synthesized audio data comprising synthesized acoustic features and synthesized prosodic features. The TTS generator 420 generates the synthesized audio data, generally as described in FIG. 4. The TTS generator includes an acoustic model which converts input text conditioned on speaker information into spectrograms. The acoustic model includes a speaker encoder, a synthesizer encoder, a variant adaptor, and a synthesizer decoder. The speaker encoder is pre-trained using independent dataset to generate speaker embeddings. The synthesizer encoder converts phoneme embedding sequence into phoneme hidden sequence. The variance adaptor adds different variance information into the hidden sequence. The variant adaptor includes acoustic feature predictors and prosodic feature predictors to predict acoustic features and prosodic features based on the phoneme embeddings and speaker embeddings. The synthesizer decoder converts the adapted hidden sequence into spectrogram sequences (e.g., Mel-spectrogram sequence). The synthesized audio data includes the spectrogram data. Alternatively, or additionally, the synthesized audio data includes audio waveforms generated by a vocoder based on the spectrogram. The synthesized acoustic features include pitch, energy, and duration associated with the synthesized audio. The synthesized acoustic features include rhythm, stress, and intonation associated with the synthesized audio.

At block 706, the communication platform 310 determines a first classification prediction using a first discriminator model based on ground truth acoustic features associated with the training audio data, the synthesized acoustic features, the training transcript data, and the speaker data. The trainer engine 445 provides the synthesized acoustic features and ground truth acoustic features randomly to the first discriminator model. Similar to the synthesized acoustic features, the ground truth acoustic features include pitch, energy, and duration associated with the training audio data. The first discriminator model predicts if received acoustic features are from a real audio (e.g., the training audio data) or a fake audio (e.g., the synthesized audio), generally as described in FIG. 4. In some examples, the trainer engine 445 implements a speaker encoder to extract a training speaker embedding from the training data sample and provides the training speaker sample to the TTS model, the first discriminator model, and the second discriminator model. In some examples, the TTS model includes a speaker encoder for extracting a training speaker embedding from the training data sample, and provides the training speaker embedding together with the training transcript data to the first discriminator model and the second discriminator model as context.

At block 708, the communication platform 310 determines a second classification prediction using the second discriminator model based on ground truth prosodic features associated with the training audio data, the synthesized prosodic features, the training transcript data, and the training speaker data. The trainer engine 445 provides the synthesized prosodic features and ground truth prosodic features randomly to the second discriminator model. Similar to the synthesized prosodic features, the ground truth prosodic features include rhythm, stress, and intonation associated with the training audio data. The second discriminator model predicts if received prosodic features are from a real audio (e.g., the training audio data) or a fake audio (e.g., the synthesized audio), generally as described in FIG. 4. In some examples, the trainer engine 445 takes the training transcript data and the training speaker data as context for predicting.

At block 710, the communication platform 310 trains the first discriminator model and the second discriminator model by adjusting a first set of weight parameters associated with the first discriminator model and the second discriminator model based on the first classification prediction, the second classification prediction, and a ground-truth classification. The trainer engine 445 trains the first discriminator model and the second discriminator model, generally as described in FIG. 4. For example, the trainer engine 445 uses an optimization algorithm to minimize a total discriminator loss associated with the first classification prediction and the second classification prediction, thereby obtaining a first set of optimized weight parameters associated with the first discriminator model and the second discriminator model.

At block 712, the communication platform 310 trains the TTS model to obtain a trained TTS model by adjusting a second set of weight parameters associated with the TTS model based on the ground truth acoustic features, the ground truth prosodic features, the synthesized acoustic features, the synthesized prosodic features, the first classification prediction, and the second classification prediction. The trainer engine 445 trains the TTS model, generally as described in FIG. 4. For example, the trainer engine 445 uses an optimization algorithm to minimize a total optimization loss, which includes an adversarial loss associated with the total discriminator loss at block 710 and a generator loss associated with the synthesized acoustic features and the synthesized prosodic features. The trainer engine then obtains a second set of optimized weight parameters associated with the TTS model.

The trained TTS model can be used for speech synthesis. For example, a user provides a text input and speaker information to the trained TTS model. The TTS model generates a synthesized audio with improved acoustic features and prosodic features. The speaker information provided by the user can be an audio sample representing certain voice features the user wanted for the synthesized audio. Alternatively, or additionally, a user selects a pre-defined speaker voice for the synthesized audio.

The example process 700 illustrates a method for multi-modal adversarial training for zero-shot voice cloning. However, not every step in the example process 700 may be needed, some other steps may be added, or the order of the steps may be changed. Alternatively, the example process 700 can be performed by a communication application 450 installed on a client device 340.

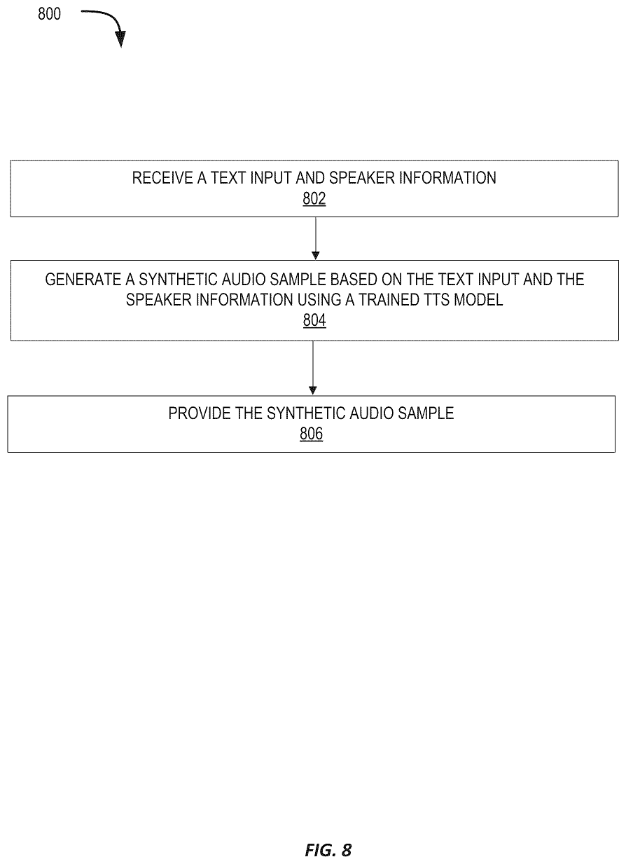

Referring now to FIG. 8, FIG. 8 shows an example process 800 for speech synthesis using the TTS model trained in FIG. 7. The example process 800 will be discussed with respect to the system 400 shown in FIG. 4; however, any suitable system for speech synthesis may be used.

At block 802, a client device 340 receives a text input and speaker information. A user associated with the client device 340 types in a text that needs to be converted to audio. Besides the text input, the user also provides an audio sample representing certain voice features the user wanted for the synthesized audio. Alternatively, or additionally, a user selects a pre-defined speaker voice for the synthesized audio. In some examples, the user is in a video conference. The user wants to hide his/her own voice, wants to imitate another person's voice, or has other reasons to provide a voice different from his original voice. In some examples, the user is mute, and wants to speak in the video conference. In some examples, the user is creating an audio or video clip involving either a real person or a fictional character speaking. In some examples, the user is in a video games, and wants a unique voice for the character he is playing in the video game. These are just some nonlimiting example use cases where the TTS model trained in FIG. 7 can be used for speech synthesis or zero-shot voice cloning. It should be understood that the TTS generator trained in FIG. 7 may be applicable to any suitable types of speech synthesis or zero-shot voice cloning.

At block 804, the client device 340 generates a synthetic audio sample based on the text input and the speaker information using a trained TTS model. In some examples, the communication platform 310 provides the TTS model trained in FIG. 7 to the communication application 450 installed on the client device 340, as part of the local TTS generator 470. In some examples, the communication platform 310 provides the trained TTS model to the TTS generator 420, and the client device 340 accesses the trained TTS model or the TTS generator 420 on the communication platform 310. The trained TTS model generates a synthesized audio sample based on the text input and the speaker information.

At block 806, the client device 340 provides the synthetic audio sample. In some examples, the synthetic audio sample is accessible on a GUI of the communication application 450. The user associated with client device 340 play the synthetic audio sample before it is available to other users or another application. In some examples, the synthetic audio sample is directly provided to other users or another application. For example, in a video conference, the user associated with the client device 340 plays to the generated synthetic audio sample first before allowing it to play to other users in the video conference. Alternatively, the communication application provides the synthetic audio sample to all the users in the video conference at the same time via audio streaming.

The example process 800 illustrates a method for speech synthesis using a TTS model trained in FIG. 7. Alternatively, the example process 800 can be performed by the communication platform 310 or any other suitable service provider.

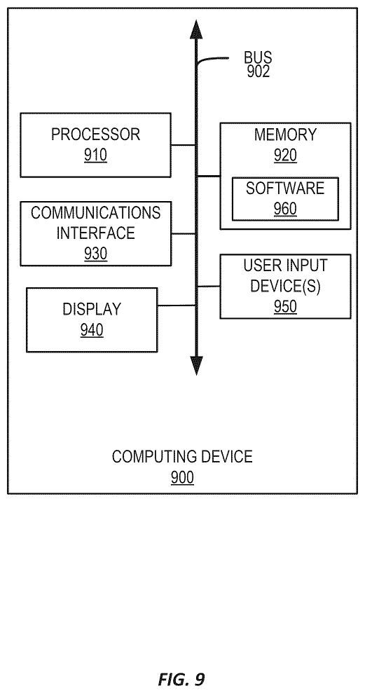

Referring now to FIG. 9, FIG. 9 shows an example computing device 900 suitable for use in example systems or methods for multi-modal adversarial training for zero-shot voice cloning. The example computing device 900 includes a processor 910 which is in communication with the memory 920 and other components of the computing device 900 using one or more communications buses 902. The processor 910 is configured to execute processor-executable instructions stored in the memory 920 to perform one or more methods for multi-modal adversarial training for zero-shot voice cloning or speech synthesis using a TTS model trained with multi-modal adversarial training, according to different examples, such as part or all of the example processes 700 and 800 described above with respect to FIGS. 7 and 8. In some embodiments, the computing device may include software 960 for executing one or more methods described herein, such as for example, one or more steps of processes 700 and 800. The computing device 900, in this example, also includes one or more user input devices 950, such as a keyboard, mouse, touchscreen, microphone, etc., to accept user input. The computing device 900 also includes a display 840 to provide visual output to a user.

The computing device 900 also includes a communications interface 630. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing training transcript data and training speaker data;
generating synthesized audio data based on the training transcript data and training speaker data using a text-to-speech (TTS) model, the synthesized audio data comprising synthesized acoustic features and synthesized prosodic features;
determining a first classification prediction using a first discriminator model based on ground truth acoustic features associated with training audio data corresponding to the training transcript data, the synthesized acoustic features, the training transcript data, and the training speaker data;
determining a second classification prediction using a second discriminator model based on ground truth prosodic features associated with training audio data corresponding to the training transcript data, the synthesized prosodic features, the training transcript data, and the training speaker data; and
training the first discriminator model and the second discriminator model by adjusting a first set of weight parameters associated with the first discriminator model and the second discriminator model based on the first classification prediction, the second classification prediction, and a ground-truth classification; and
training the TTS model to generate a trained TTS model by adjusting a second set of weight parameters associated with the TTS model based on the ground truth acoustic features, the ground truth prosodic features, the synthesized acoustic features, the synthesized prosodic features, the first classification prediction, and the second classification prediction.

2. The method of claim 1, further comprising:
accessing an input text and speaker data; and
generating a synthesized audio using the trained TTS model based on the input text and speaker data.

3. The method of claim 2, wherein the training speaker data comprises a training audio sample from the training audio data, wherein the method further comprises:
extracting a training speaker embedding from the training audio sample; and
providing the training speaker embedding to the TTS model, the first discriminator model, and the second discriminator model.

4. The method of claim 1, wherein the synthesized acoustic features comprise pitch, energy, and duration.

5. The method of claim 1, wherein the synthesized acoustic features comprise rhythm, stress, and intonation.

6. The method of claim 1, wherein the first discriminator model and the second discriminator model comprise a transformer-based encoder and a transformer-based decoder.

7. The method of claim 1, further comprising:
providing the synthesized acoustic features and the ground truth acoustic features randomly to the first discriminator model; and
determining the first classification prediction indicating if received acoustic features are from the training audio data or the synthesized audio data.

8. The method of claim 1, further comprising:
providing the synthesized prosodic features and the ground truth prosodic features randomly to the second discriminator model; and
determining the second classification prediction indicating if received prosodic features are from the training audio data or the synthesized audio data.

9. The method of claim 1, further comprising:
determining a first set of optimized weight parameters associated with the first discriminator model and the second discriminator model by minimizing a total discriminator loss associated with the first classification prediction and the second classification prediction using an optimization algorithm.

10. The method of claim 9, further comprising:
determining a second set of optimized weight parameters associated with the TTS model by minimizing a total optimization loss, wherein the total optimization loss comprises an adversarial loss associated with the total discriminator loss and a generator loss associated with the synthesized acoustic features and the synthesized prosodic features.

11. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access training transcript data and training speaker data;
generate synthesized audio data based on the training transcript data and training speaker data using a text-to-speech (TTS) model, the synthesized audio data comprising synthesized acoustic features and synthesized prosodic features;
determine a first classification prediction using a first discriminator model based on ground truth acoustic features associated with training audio data corresponding to the training transcript data, the synthesized acoustic features, the training transcript data, and the training speaker data;
determine a second classification prediction using a second discriminator model based on ground truth prosodic features associated with the training audio data corresponding to the training transcript data, the synthesized prosodic features, the training transcript data, and the training speaker data; and
train the first discriminator model and the second discriminator model by adjusting a first set of weight parameters associated with the first discriminator model and the second discriminator model based on the first classification prediction, the second classification prediction, and a ground-truth classification; and
train the TTS model to obtain a trained TTS model by adjusting a second set of weight parameters associated with the TTS model based on the ground truth acoustic features, the ground truth prosodic features, the synthesized acoustic features, the synthesized prosodic features, the first classification prediction, and the second classification prediction.

12. The system of claim 11, wherein the one or more processors are configured to execute further processor-executable instructions stored in the non-transitory computer-readable medium to:
access an input text and speaker data; and
generate a synthesized audio using the trained TTS model based on the input text and the speaker data.

13. The system of claim 11, wherein the training speaker data comprises a training audio sample from the training audio data, wherein the one or more processors are configured to execute further processor-executable instructions stored in the non-transitory computer-readable medium to:
extracting a training speaker embedding from the training audio sample; and
providing the training speaker embedding to the TTS model, the first discriminator model, and the second discriminator model.

14. The system of claim 11, wherein the synthesized acoustic features comprise pitch, energy, and duration, wherein the synthesized acoustic features comprise rhythm, stress, and intonation, and wherein the first discriminator model and the second discriminator model comprise a transformer-based encoder and a transformer-based decoder.

15. The system of claim 11, wherein the one or more processors are configured to execute further processor-executable instructions stored in the non-transitory computer-readable medium to:
provide the synthesized acoustic features and the ground truth acoustic features randomly to the first discriminator model;
determine the first classification prediction indicating if received acoustic features are from the training audio data or the synthesized audio data;
provide the synthesized prosodic features and the ground truth prosodic features randomly to the second discriminator model; and
determine the second classification prediction indicating if received prosodic features are from the training audio data or the synthesized audio data.

16. The system of claim 11, wherein the one or more processors are configured to execute further processor-executable instructions stored in the non-transitory computer-readable medium to:
determine a first set of optimized weight parameters associated with the first discriminator model and the second discriminator model by minimizing a total discriminator loss associated with the first classification prediction and the second classification prediction using an optimization algorithm.

17. The system of claim 16, wherein the one or more processors are configured to execute further processor-executable instructions stored in the non-transitory computer-readable medium to:
determine a second set of optimized weight parameters associated with the TTS model by minimizing a total optimization loss, wherein the total optimization loss comprises an adversarial loss associated with the total discriminator loss and a generator loss associated with the synthesized acoustic features and the synthesized prosodic features.

18. A non-transitory computer-readable medium comprising processor-executable instructions configured to cause one or more processors to:
access training transcript data and training speaker data;
generate synthesized audio data based on the training transcript data and training speaker data using a text-to-speech (TTS) model, the synthesized audio data comprising synthesized acoustic features and synthesized prosodic features;
determine a first classification prediction using a first discriminator model based on ground truth acoustic features associated with training audio data corresponding to the training transcript data, the synthesized acoustic features, the training transcript data, and the training speaker data;
determine a second classification prediction using a second discriminator model based on ground truth prosodic features associated with the training audio data corresponding to the training transcript data, the synthesized prosodic features, the training transcript data, and the training speaker data; and
train the first discriminator model and the second discriminator model by adjusting a first set of weight parameters associated with the first discriminator model and the second discriminator model based on the first classification prediction, the second classification prediction, and a ground-truth classification; and
train the TTS model to obtain a trained TTS model by adjusting a second set of weight parameters associated with the TTS model based on the ground truth acoustic features, the ground truth prosodic features, the synthesized acoustic features, the synthesized prosodic features, the first classification prediction, and the second classification prediction.

19. The non-transitory computer-readable medium of claim 18, further comprising processor-executable instructions configured to cause one or more processors to:
provide the synthesized acoustic features and the ground truth acoustic features randomly to the first discriminator model;
determine the first classification prediction indicating if received acoustic features are from the training audio data or the synthesized audio data;
provide the synthesized prosodic features and the ground truth prosodic features randomly to the second discriminator model; and
determine the second classification prediction indicating if received prosodic features are from the training audio data or the synthesized audio data.

20. The non-transitory computer-readable medium of claim 18, further comprising processor-executable instructions configured to cause one or more processors to:
determine a first set of optimized weight parameters associated with the first discriminator model and the second discriminator model by minimizing a total discriminator loss associated with the first classification prediction and the second classification prediction using an optimization algorithm.
determine a second set of optimized weight parameters associated with the TTS model by minimizing a total optimization loss, wherein the total optimization loss comprises an adversarial loss associated with the total discriminator loss and a generator loss associated with the synthesized acoustic features and the synthesized prosodic features.
